(19) United States
(12) Patent Application Publication
(10) Pub. No.: US 2007/0226190 A1
(43) Pub. Date: Sep. 27, 2007

(54) Enhanced content configuration

(75) Inventors: Matthew L. Lorenzen, Cupertino, CA (US); Lee Lorenzen, Pacific Grove, CA (US); Craig W. Johnson, Portola Valley, CA (US); Micah S. Siegel, Palo Alto, CA (US)

Correspondence Address: VAN PELT, YI & JAMES LLP, 10050 N. FOOTHILL BLVD #200, CUPERTINO, CA, 95014, US

(73) Assignee: MyWare, Inc.

(21) Appl. No.: 11/486,405

(22) Filed: Jul. 12, 2006

Related U.S. Application Data
(60) Provisional application No. 60/784,835, filed on Mar. 21, 2006.
(60) Provisional application No. 60/802,050, filed on May 18, 2006.

(51) Int. Cl. G06F 17/30; G06F 17/00

(52) U.S. Cl. 707/3; 715/530; 715/513; 707/5

(57) ABSTRACT

An indication is received. The indication is associated with a selection of an identifier on a webpage that at least in part specifies an enhanced content configuration. An enhanced content configuration is set at least in part by using the received indication. The enhanced content configuration can be used to enhance content included on a webpage.

### CROSS REFERENCE TO OTHER APPLICATIONS

This application claims priority to U.S. Provisional Patent Application No. 60/784,835 (Attorney Docket No. MYWAP001+) entitled ENHANCED CONTENT MANAGER filed Mar. 21, 2006 which is incorporated herein by reference for all purposes, and U.S. Provisional Patent Application No. 60/802,050 (Attorney Docket No. MYWAP002+) entitled ENHANCED CONTENT MANAGER filed May 18, 2006 which is incorporated herein by reference for all purposes.

### BACKGROUND OF THE INVENTION

Often when browsing a webpage, additional information related to an item of the webpage is desired. For example, a definition of a word found on the webpage or directions to an address found on the webpage is desired. To obtain the desired information, typically a user selects a link, if provided, on the webpage and/or performs a search for the desired information. Although a provided link can be a convenient in some cases, a link is often not provided for the desired information. In many cases, the provided link leads to incorrect, undesired, and/or unpreferred information, causing the user to backtrack to the originating webpage to pursue other search options (e.g., a user may prefer a specific electronic map provider not linked on the originating webpage). The process of searching for the desired information requires the user to leave the originating webpage or open a new browsing window. In addition to the hassle of the search process, juggling various webpages and/or various windows can be inconvenient, especially when information is quickly desired and/or desired without interrupting the browsing of the originating webpage. Therefore, there exists a need for a more efficient way of obtaining desired information associated with at least a portion of an originating webpage.

### BRIEF DESCRIPTION OF THE DRAWINGS

Various embodiments of the invention are disclosed in the following detailed description and the accompanying drawings.

FIG. 1 is a block diagram illustrating an embodiment of an enhanced content environment.

FIG. 2 is a block diagram illustrating an embodiment of an enhanced content manager.

FIG. 3 is a flowchart illustrating an embodiment of a process for associating enhanced content with a display of indicated content.

FIG. 4 is a flowchart illustrating an embodiment of a process for receiving enhanced content from a specified enhanced content provider.

FIG. 5 is a diagram illustrating an example of an enhanced content option menu.

FIG. 6 is a flowchart illustrating an embodiment of a process for processing enhanced content.

FIG. 7 is a diagram illustrating an example of an overlaid enhanced content display.

FIG. 8 is a flowchart illustrating an embodiment of a process for setting a preferred enhanced content provider associated with an enhanced content category.

FIG. 9 is a diagram illustrating an example of an enhanced content configuration window.

FIG. 10 is a flow chat illustrating an embodiment of a process for configuring an enhanced content preference.

FIG. 11 is a diagram illustrating an example of a webpage including a link associated with configuring an enhanced content preference.

### DETAILED DESCRIPTION

The invention can be implemented in numerous ways, including as a process, an apparatus, a system, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Enhanced content management is disclosed. In some cases, a user desires to specify a desired information provider. For example, a user may prefer one provider to provide a map for an address on a webpage, but another to provide a definition of a word or a program for dialing a phone number. In some embodiments, an enhanced content manager gives users the choice of which enhanced content provider should be used to provide particular information on a webpage without requiring the user to leave the webpage. In some embodiments, content included on the webpage that is to be enhanced is associated with enhanced content from a specified enhanced content provider previously specified from among a plurality of enhanced content providers. For example, user-desired enhanced content associated with one or more user-indicated portions of the webpage is overlaid on the webpage in a display bubble. Types of enhanced content include one or more of the following: text, image, link, audio, video, data input field, and various other multimedia and web content. Examples of enhanced content include one or more of the following: a preview of a link, an advertisement, a definition, a translation, an article, a search result, directory information, a stock quote, a map, a navigation direction, a satellite image, a street level image, weather information, a review of a product, data enabling purchase of a product and/or service, and data enabling communication (e.g., telephonic call, video conference, instant message, text message, email, fax). The overlaid enhanced content is displayed without using and/or altering encoding of the webpage. For example, the overlaid enhanced content is displayed without altering the underlying markup language and scripting language encoding (e.g., HTML, XML, Java Script, AJAX, etc.) used by a web browser to render the webpage. A user may indicate a portion of the web page by selecting text or pausing over a link, as well as other methods. In some embodiments, the enhanced content is selected by using a user indication (e.g., a selection of item on a context specific shortcut menu) specifying which enhanced content category should be associated with the content to be enhanced.

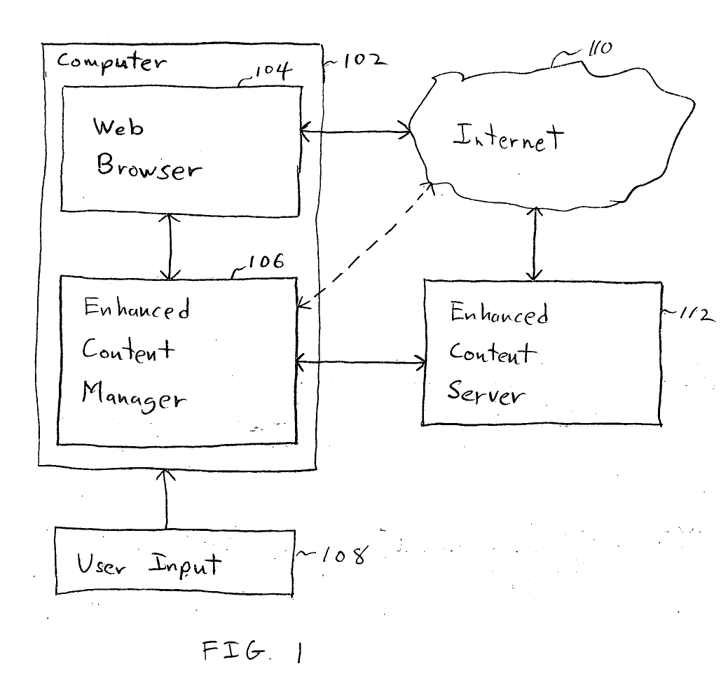

FIG. 1 is a block diagram illustrating an embodiment of an enhanced content environment. Computer 102 receives user input 108 from, for example, a keyboard and/or a curser pointing device. Computer 102 includes web browser 104 and enhanced content manager 106. Web browser 104 is used by a user of computer 102 to display web content. Web browser 104 accesses Internet 110 to obtain web content. Enhanced content manager 106 manages enhanced content associated with at least a portion of a webpage displayed by web browser 104. Managing enhanced content includes obtaining enhanced content and/or managing configurations/preferences associated with enhanced content. In various embodiments, enhanced content manager 106 is included in and/or executed in computer 102 as one or more of the following: a web browser plug-in, an application program, a background software process, an imbedded function of a web browser, and an imbedded function of an operating system.

Data is communicated between web browser 104 and enhanced content manager 106. For example, data indicating web browser content to be enhanced is communicated between web browser 104 and enhanced content manger 106. In some embodiments, user interaction data associated with computer 102 is communicated between enhanced content manager 106 and enhanced content server 112. Examples of user interaction data includes data associated with one or more of the following: an identifier of a desired enhanced content, a menu selection, a web content selection, an advertisement tracking information, and a user input (e.g., cursor movement, cursor selection, keyboard input). In some embodiments, by receiving user interaction data from multiple enhanced content managers, enhanced content server 112 can aggregate and/or process user interaction data from multiple users. In some embodiments, at least a portion of the enhanced content obtained by enhanced content manger 106 is received from enhanced content server 112. Enhanced content server 112 is connected to Internet 110 and can obtain content from Internet 110. For example, at least a portion of enhanced content requested by enhanced content manager 106 is returned by enhanced content server 112 by obtaining content from an enhanced content provider accessed through Internet 110. In some embodiments, enhanced content server 112 provides cached data to enhanced content manager 106. In some embodiments, at least a portion of the enhanced content is obtained by enhanced content manager 106 is obtained directly from an enhanced content provider through Internet 110.

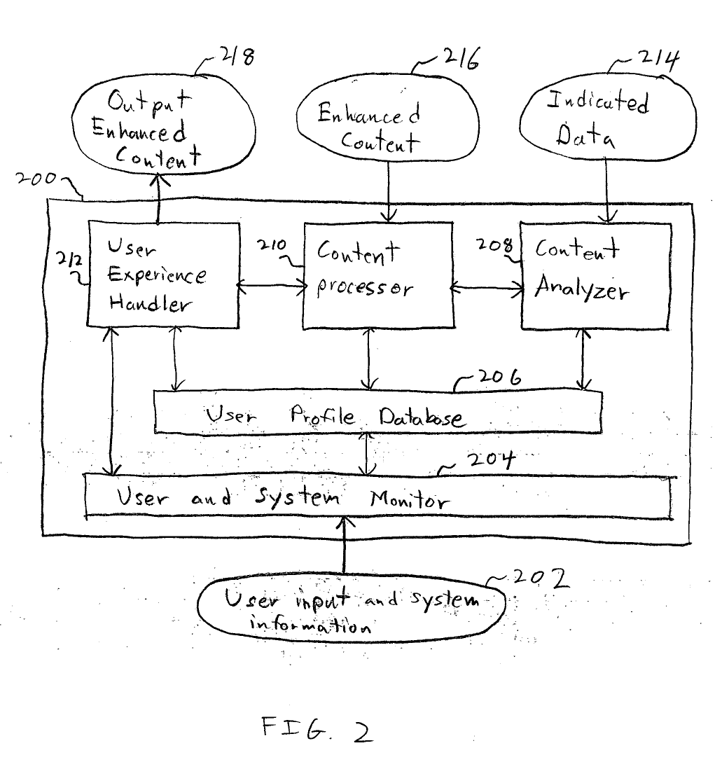

FIG. 2 is a block diagram illustrating an embodiment of an enhanced content manager. In some embodiments, enhanced content manager 200 is enhanced content manager 106 of FIG. 1. Enhanced content manager 200 includes user and system monitor 204, user profile database 206, content analyzer 208, content processor 210, and user experience handler 212. User and system monitor 204 monitors and processes user input and system information 202. User input and system information 202 includes at least a portion of input data received from one or more user input devices and/or status, indication, or state information associated with an operating system, an application, a process, or a component included a system containing enhanced content manager 200. Indicated data 214 is associated with content indicated by a user to be enhanced. For example, the indicated data includes a highlighted word in a webpage to be enhanced by obtaining a definition of the word. Content analyzer 208 analyzes indicated data 214 to determine one or more possible enhanced content types that can be obtained. For example, the indicated data can be identified as an address and one possible enhanced content type is a map showing the location of the address.

Enhanced content 216 includes enhanced content received through an enhanced content server and/or the Internet in response to a request for the enhanced content. Content processor 210 processes enhanced content 216. For example, content processor 210 requests the enhanced content from an enhanced content provider determined at least in part by using analysis of content analyzer 208. The requested enhanced content is received by content processor 210 and processed into a format associated with a desired output enhanced content format. Output enhanced content 218 includes at least a portion of enhanced content 216 in an output format (e.g., format of a content display bubble overlaid on content to be enhanced). User experience handler 212 at least in part outputs and/or manages output enhanced content 218. User experience handler 212 uses data from user and system monitor 204 to perform one or more of its functions. For example, user experience handler 218 manages displaying of an enhanced content display bubble in response to a user input monitored by user and system monitor 204. User and profile database 206 includes data associated with one or more of the following: user preferences (e.g., a user preference of a preferred enhanced content provider), a user profile (e.g., data identifying demographics of user), user interaction data (e.g., a record of user curser selection and movements associated with enhanced content), and advertisement tracking data (e.g., interaction data associated with an advertisement—advertisement clicks, actions, amount of time spent interacting with advertisement). User profile database 206 is read, updated, and/or used by user experience handler 212, content processor 210, content analyzer 208, and user and system monitor 204. The components of enhanced content manager 200 in the example shown are merely illustrative. One or more of the components and/or interactions between components may be optional and additional components not shown in the Figure may be included.

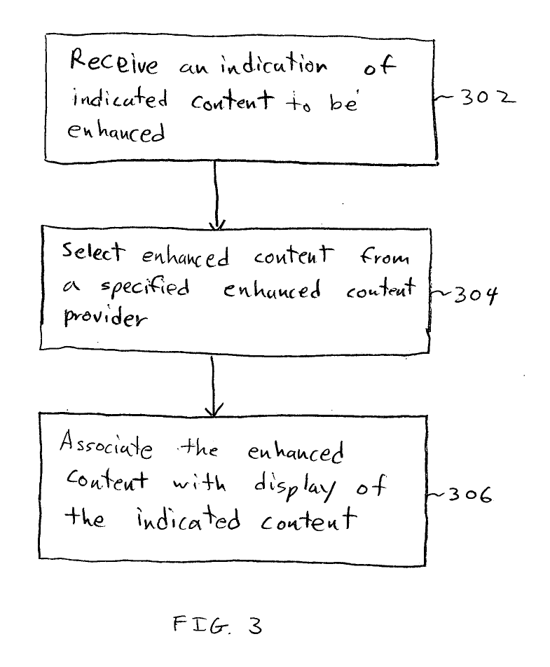

FIG. 3 is a flowchart illustrating an embodiment of a process for associating enhanced content with a display of indicated content. At 302, an indication of indicated content to be enhanced is received. In some embodiments, the indication is associated with indicated data 214 of FIG. 2. The indicated content is a portion of content, such as a webpage, that has been indicated as of interest to be enhanced. In various embodiments, a user indicates a portion of content in one or more of the following ways: highlighting desired content, underlining desire content, selecting (e.g., clicking, touching) desired content with a cursor/pointer, pausing over desired content with a cursor/pointer, and gesturing (e.g., circling, boxing, underlining) desired content with a cursor/pointer. The cursor/pointer can be controlled by a user by using one or more of the following: a mouse, a touch pad, a pointing stick, a tablet, a joystick, a keyboard, a touch screen device, and any pointing device. At 304, enhanced content from a specified enhanced content provider is selected. The selected enhanced content is associated with the indicated content. The specified enhanced content provider is determined at least in part by using a predetermined, default, and/or indicated preference of a preferred enhanced content provider. In some embodiments, the preference of a preferred enhanced content provider is associated with a specific category of enhanced content. At 306, enhanced content is associated with a display of the indicated content. The enhanced content includes at least a portion of the selected enhanced content. The selected enhanced content may be processed before being associated with the display of the indicated content. In some embodiments, associating the enhanced content with the display of the indicated content includes displaying the enhanced content in association with the display of the indicated content. Examples of displaying the enhanced content include overlaying the enhanced content over the display of the indicated content, displaying the enhanced content in a web browser window/tab/pop-up, and displaying the enhanced content in a display bar (e.g., sidebar, toolbar).

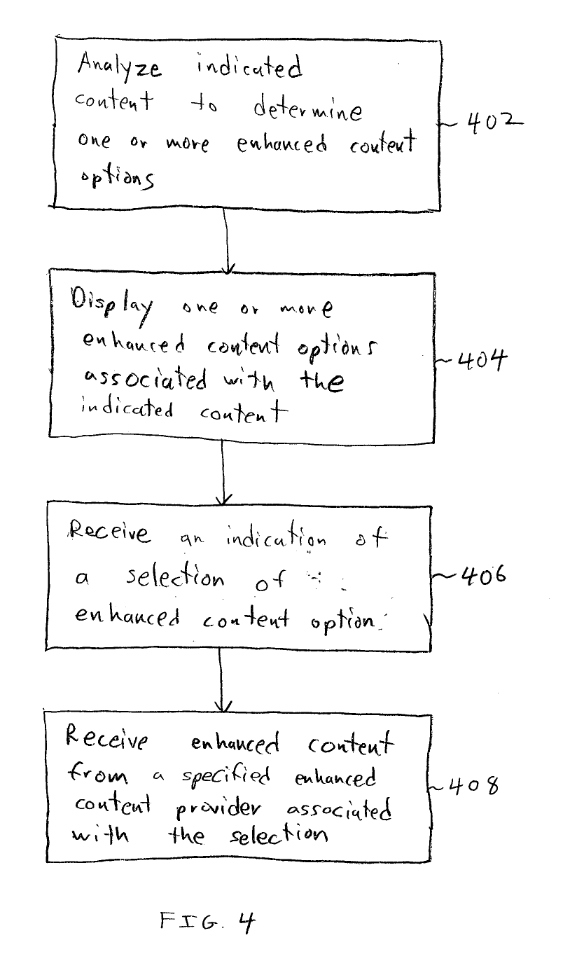

FIG. 4 is a flowchart illustrating an embodiment of a process for receiving enhanced content from a specified enhanced content provider. In some embodiments, the process of FIG. 4 is included in 304 of FIG. 3. At 402, indicated content is analyzed to determine one or more enhanced content options. In some embodiments, the indicated content includes at least a portion of the indicated content in 302 of FIG. 3. In some embodiments, the enhanced content options include one or more options associated with which enhanced content to select and/or how to associate/display enhanced content. For example, if the indicated content is analyzed to be likely an address, enhanced content options corresponding to various categories of enhanced content possible to be obtained for an address are determined. In some embodiments, the determined enhanced content options are a subset of enhanced content options determined to be most likely relevant (e.g., most likely selected by a user) to the indicated content from a set of available enhanced content options. In various embodiments, analyzing the indicated content includes performing one or of the following: pattern matching, semantic matching, and using previous selection/analysis history data. At 404, one or more of the determined enhanced content options are displayed. In some embodiments, the options are displayed as a menu of enhanced content options. The menu is associated with one or more of the following: a menu bar, a toolbar, a sidebar menu, a shortcut menu (e.g., right-click menu), a context menu, an icon menu, and a pop-up menu. For example, a user may right-click on the indicated content to display a dynamically determined shortcut menu containing menu items corresponding to determined enhanced content options.

The menu of options may also contain default menu options. At 406, an indication of a selection of an enhanced content option is received. For example, a selection of a menu item associated with a displayed menu of enhanced content options is received. In some embodiments, the selection is associated with a specific category of enhanced content. At 408, enhanced content is received from a specified enhanced content provider associated with the selection. In some embodiments, the enhanced content is received by an enhanced content manager. The received enhanced content is received in response to a request determined at least in part by using the enhanced content option selection. At least a portion of the enhanced content can be received via an enhanced content server and/or directly received from the enhanced content provider. The specified enhanced content provider is determined by using a predetermined configuration and/or by using a dynamically indicated enhanced content option. In some embodiments, a specified enhanced content provider is predetermined for each category of enhanced content that can correspond to a selectable enhanced content option displayed in 404.

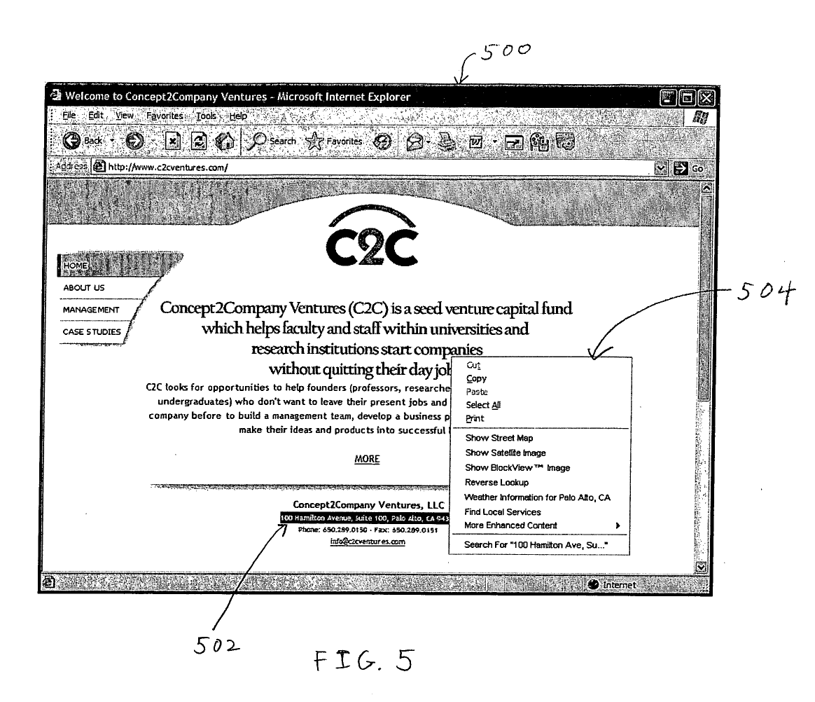

FIG. 5 is a diagram illustrating an example of an enhanced content option menu. In some embodiments, the menu shown in the Figure is associated with 404 of FIG. 4. Web browser window 500 is displaying a webpage. The webpage includes indicated content 502. Indicated content 502 is an address that has been highlighted by a user as indication of content to be enhanced. Menu 504 includes a shortcut menu in response to a selection of indicated content 504. Menu 504 includes items associated with enhanced content options. A portion of the menu items are determined by analyzing indicated content 502. For example, since indicated content 504 includes data associated with a location, menu 504 includes menu items of location associated enhanced content options. The menu items, “Show Street Map”, “Show Satellite Image”, “Show BlockView Image”, “Reverse Lookup”, “Weather Information”, and “Find Local Services” are each associated an enhanced content category and a specified enhanced content provider of that category. If the desired enhanced content option is not listed in menu 504, a user may select “More Enhanced Content” menu item to cascade a list of all available enhanced content options. By analyzing indicated content 502 to display the most likely relevant subset of all enhanced content options, a user is able to more quickly select the desired enhanced content option.

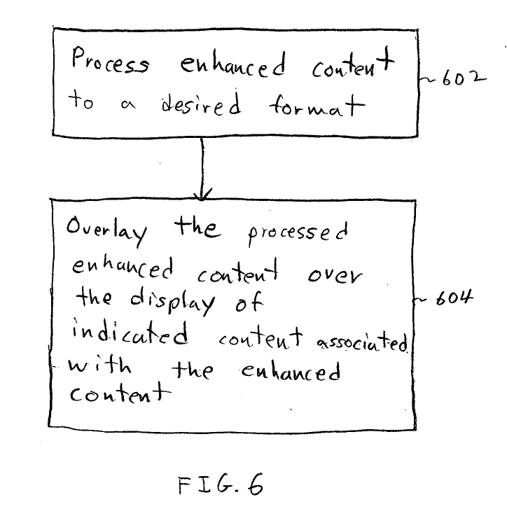

FIG. 6 is a flowchart illustrating an embodiment of a process for processing enhanced content. In some embodiments, the process of FIG. 6 is included in 306 of FIG. 3. At 602, enhanced content is processed to a desired format. The enhanced content includes at least a portion of content received from an enhanced content provider. In some embodiments, processing the enhanced to the desired format includes reformatting and/or converting at least a portion of the enhanced content to a display format of the enhanced content. In some cases, the enhanced content is formatted to fit in a smaller display space than an original display format of the content. In some embodiments, one or more options for formatting the enhanced content can be configured using an enhanced content manager. For example, formatting preferences, such as enhanced content display size, can be specified in configuration preferences of the enhanced content manager. In some embodiments, one or more preferences specified in a web browser setting are used in processing the enhanced content. For example, font size, font preference, display plug-in preference, security preferences, and various other web content preferences of a web browser are used in processing the enhanced content. In various embodiments one or more of following settings are used in processing the enhanced content: an operating system setting, a toolbar preference setting, and a setting specified online. At 604, the processed enhanced content is displayed over the display of the associated indicated content. In some embodiments, overlaying the processed content includes displaying the enhanced content in a content display bubble. In some embodiments, the overlaid enhanced content display is closed/hidden in association with one or more of following: a selection of a user interface button (e.g., a button for closing a display area), a keyboard command, movement of a cursor/pointer, and a cursor/pointer selection outside a display area of the enhanced content.

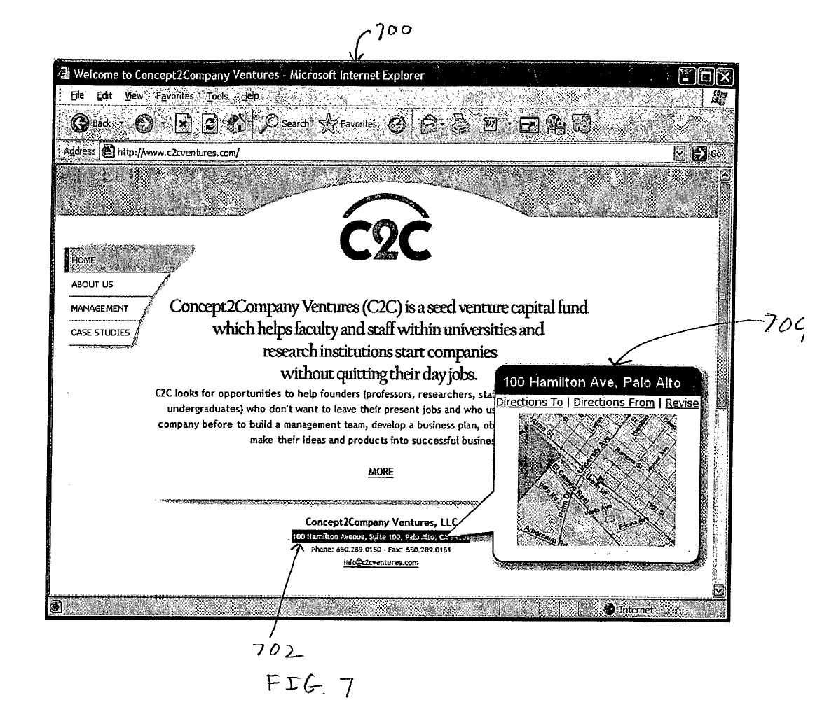

FIG. 7 is a diagram illustrating an example of an overlaid enhanced content display. In some embodiments, the example shown in the Figure is associated with 604 of FIG. 6. Web browser window 700 is displaying a webpage. The webpage includes indicated content 702. Indicated content 702 includes an address that has be highlighted by a user as indication of content to be enhanced. Display bubble 704 includes enhanced content overlaid on the display of the webpage including indicated content 702. Display bubble 704 includes an indicator pointing to indicated content 702. When the webpage of window 700 is scrolled, display bubble 704 moves is together with the webpage. A link selected on display bubble 704 displays content associated with the selected link in the same display bubble and/or in a web browser window. In some cases, the displayed enhanced content includes one or more input fields, and data responsive to a submitted data in the input fields is displayed in the enhanced content display space and/or a web browser window.

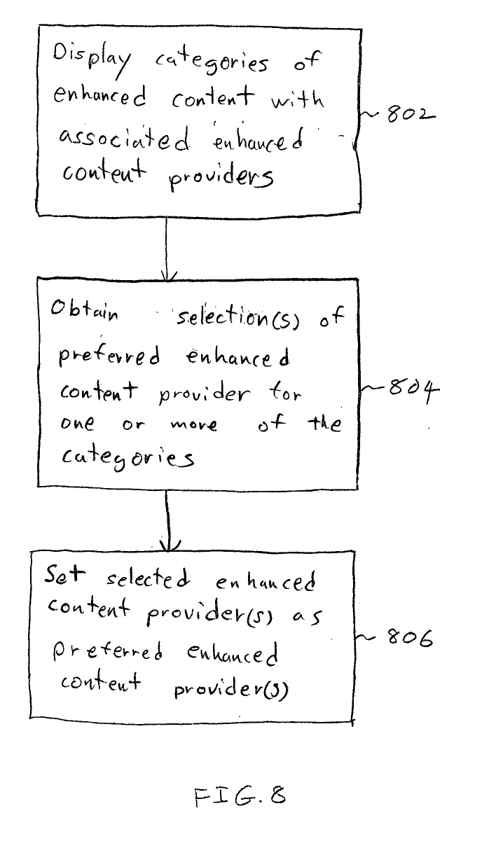

FIG. 8 is a flowchart illustrating an embodiment of a process for setting a preferred enhanced content provider associated with an enhanced content category. In some embodiments, the preference is at least in part specified by using enhanced content manager 200 of FIG. 2. In some embodiments, the preferences are at least in part specified by modifying configuration preferences of a web browser. At 802, categories of enhanced content with associated enhanced content providers are displayed. Each category of enhanced content is associated with one or more enhanced content providers, and one enhanced content provider is specified as a preferred enhanced content provider of the category. In some embodiments, a new enhanced content provider can be added by providing a URL and/or an IP address that can be used communicated with the new enhanced content provider. At 804, one or more selections of a preferred enhanced content provider for one or more of the categories are obtained. For example, a preferred enhanced content provider is selected from a dropdown list of one or more enhanced content providers associated with an enhanced content category. At 806, the selected enhanced content providers are set as the preferred enhanced content providers. Enhanced content is obtained from the preferred enhanced content provider of the desired enhanced content category. In some embodiments, an enhanced content category is not associated with any preferred providers. For example, link preview enhanced content is generated directly by an enhanced content manager.

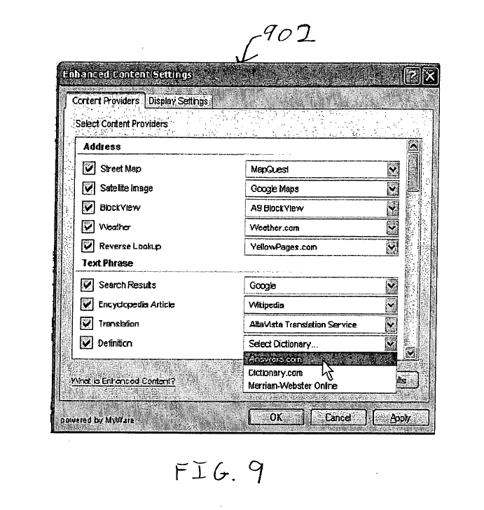

FIG. 9 is a diagram illustrating an example of an enhanced content configuration window. In some embodiments, the example shown in the Figure is associated with 804 of FIG. 8. Configuration window 902 lists enhanced content categories with a dropdown box listing associated enhanced content providers of the category. The listings of the enhanced content categories are grouped into an enhanced content category group. Examples of enhanced content category groups are (1) a location associated group including enhanced content categories: street map, satellite image, block view, weather, and reverse lookup; (2) a text phrase associated group including enhanced content categories: search results, encyclopedia article, translation, and definition; (3) a stock symbol associated group including enhanced content categories: quote detail and company snapshot; (4) a directory associated group including enhanced content categories: call out and directory lookup; and (5) a product associated group including enhanced content categories: reviews, buy-it-now, and price comparison. Each enhanced content category may be enabled and/or disabled by checking and unchecking an associated checkbox. A preferred enhanced content provider is selected for each enhanced content category by selecting an enhanced content provider in the corresponding dropdown box.

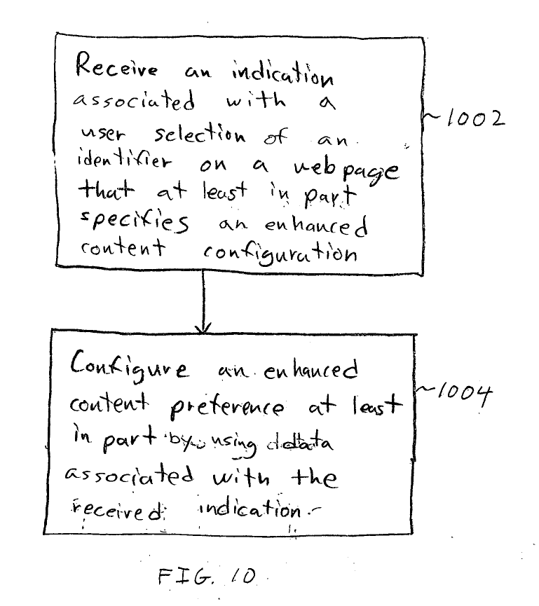

FIG. 10 is a flow chat illustrating an embodiment of a process for configuring an enhanced content preference. At 1002, an indication associated with a user selection of an identifier on a webpage that at least in part specifies an enhanced content configuration is received. The identifier may be a text link, an image link, a pop-up dialog window, and/or any content item able to specify an enhanced content preference. For example, when a user selects a link associated with automatically configuring an enhanced content configuration, an indication associated with the selection of the link is received. In some embodiments, the indication is associated with a file that specifies the enhanced content configuration. An example of the enhanced content configuration is a specification of a preferred and/or new enhanced content provider or category. At 1004, an enhanced content preference is configured at least in part by using data associated with the received indication. For example, a configuration specification file associated with the received indication is used to configure the enhanced content preference. In some embodiments, the enhanced content preference is a configuration preference of an enhanced content manager.

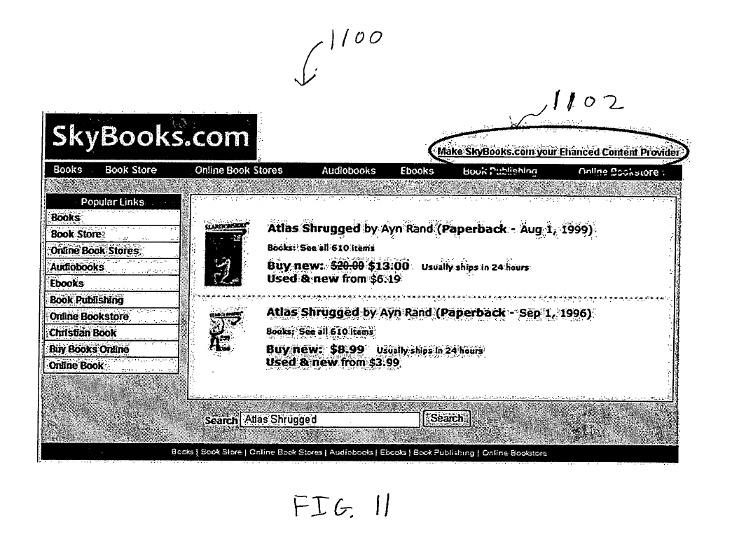

FIG. 11 is a diagram illustrating an example of a webpage including a link associated with configuring an enhanced content preference. Web browser window 1100 is displaying a webpage. The webpage includes link button 1102 associated with configuring an enhanced content preference. By selecting link button 1102, the enhanced content provider of the link button is made a preferred enhanced content provider. In some embodiments, a user is required to confirm the configuration before the configuration is implemented.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of setting an enhanced content configuration, comprising:
receiving an indication associated with a selection of an identifier on a webpage that at least in part specifies an enhanced content configuration; and
setting an enhanced content configuration at least in part by using the received indication, wherein the enhanced content configuration can be used to enhance content included on a webpage.

2. A method as recited in claim 1, wherein enhancing the webpage content includes selecting enhanced content from a specified enhanced content provider specified by the enhanced content configuration.

3. A method as recited in claim 1, wherein the identifier includes a web content link.

4. A method as recited in claim 1, wherein the indication is associated with a file that includes data specifying the enhanced content configuration.

5. A method as recited in claim 1, wherein the enhanced content configuration includes a specification of a preferred enhanced content provider.

6. A method as recited in claim 1, wherein the enhanced content configuration includes a specification of a new enhanced content provider.

7. A method as recited in claim 1, wherein the enhanced content configuration includes a specification of a new enhanced content category.

8. A system for setting an enhanced content configuration, comprising:
a processor configured to receive an indication associated with a selection of an identifier on a webpage that at least in part specifies an enhanced content configuration, and set an enhanced content configuration at least in part by using the received indication, wherein the enhanced content configuration can be used to enhance content included on a webpage; and
a memory coupled with the processor, wherein the memory is configured to provide the processor with instructions.

9. A system as recited in claim 8, wherein enhancing the webpage content includes selecting enhanced content from a specified enhanced content provider specified by the enhanced content configuration.

10. A system as recited in claim 8, wherein the identifier includes a web content link.

11. A system as recited in claim 8, wherein the indication is associated with a file that includes data specifying the enhanced content configuration.

12. A system as recited in claim 8, wherein the enhanced content configuration includes a specification of a preferred enhanced content provider.

13. A system as recited in claim 8, wherein the enhanced content configuration includes a specification of a new enhanced content provider.

14. A system as recited in claim 8, wherein the enhanced content configuration includes a specification of a new enhanced content category.

15. A computer program product for setting an enhanced content configuration, the computer program product being embodied in a computer readable medium and comprising computer instructions for:
receiving an indication associated with a selection of an identifier on a webpage that at least in part specifies an enhanced content configuration; and
setting an enhanced content configuration at least in part by using the received indication, wherein the enhanced content configuration can be used to enhance content included on a webpage.

16. A computer program product as recited in claim 15, wherein enhancing the webpage content includes selecting enhanced content from a specified enhanced content provider specified by the enhanced content configuration.

17. A computer program product as recited in claim 15, wherein the identifier includes a web content link.

18. A computer program product as recited in claim 15, wherein the indication is associated with a file that includes data specifying the enhanced content configuration.

19. A computer program product as recited in claim 15, wherein the enhanced content configuration includes a specification of a preferred enhanced content provider.

20. A computer program product as recited in claim 15, wherein the enhanced content configuration includes a specification of a new enhanced content provider.

21. A computer program product as recited in claim 15, wherein the enhanced content configuration includes a specification of a new enhanced content category.
